(19) United States
(12) Patent Application Publication
(10) Pub. No.: US 2020/0110482 A1
(43) Pub. Date: Apr. 9, 2020

(54) METHOD AND APPARATUS FOR BATTERY-FREE IDENTIFICATION TOKEN FOR TOUCH SENSING DEVICES

(71) Applicant: THE REGENTS OF THE UNIVERSITY OF COLORADO, A BODY CORPORATE, Denver, CO (US)

(72) Inventors: Tam Vu, Denver, CO (US); Phuc Nguyen, Denver, CO (US)

(21) Appl. No.: 16/349,459

(22) PCT Filed: Nov. 13, 2017
(86) PCT No.: PCT/US2017/061357

§ 371 Date: May 13, 2019

Related U.S. Application Data
(60) Provisional application No. 62/421,583, filed on Nov. 14, 2016.

(51) Int. Cl. G06F 3/044; G05F 1/45; G06F 3/041; H04L 9/38

(52) U.S. Cl. CPC G06F 3/044; H04L 9/38; G06F 3/0418; G05F 1/45

(57) ABSTRACT

The present disclosure relates to data communications. More specifically, the present disclosure relates to the generation of touch events on a capacitive touch-screen of an electronic device to communicate information to the electronic device. A method, apparatus, and system for using a user device to communicate with a touch-screen of an electronic device involves the token transmitting its identity (ID) directly through the touch-sensor by artificially modifying the effective capacitance between the touch-sensor and token surfaces. The electronic device receives the signal to identify the individual token.

### CROSS-REFERENCE TO RELATED APPLICATIONS

The present application claims the benefit of U.S. Provisional Patent Application No. 62/421,583, filed on Nov. 14, 2016, which is incorporated herein by reference.

### FIELD OF THE INVENTION

The present disclosure relates to data communications. More specifically, the present disclosure relates to the generation of touch events on a capacitive touch-screen of an electronic device to communicate information to the electronic device. A method, apparatus, and system for using a user device to communicate with a touch-screen of an electronic device involves the token transmitting its identity (ID) directly through the touch-sensor by artificially modifying the effective capacitance between the touch-sensor and token surfaces. The electronic device receives the signal to identify the individual token.

### BACKGROUND OF THE INVENTION

Touch-screen technology was first developed in the 1960's for air traffic control systems and is now a popular user interface technology on devices ranging from Automated Teller Machine (“ATMs”) and self-service terminals in grocery stores or airports, to cars, smart phones, and tablets. The touch pads used in laptops are based on similar technology. These products employ different touch-screen implementations, including analog resistive, surface capacitive, projected capacitive, surface acoustic wave, infrared and optical technology, and the like. On mobile devices, however, capacitive touch-screens have emerged as the primary user interface technology.

Mobile electronic devices now provide ubiquitous access to a vast array of media content and digital services. These devices can access email and personal photos, open cars or garage doors, pay bills and transfer funds between bank accounts, order merchandise, as well as control various functions within the home. These devices now provide the de-facto single sign-on access to a wide array of content and services.

As users increasingly rely on a variety of such devices, users tend to quickly switch between them and temporarily share them with others. Users may allow children to play games on smart phones or share a tablet with colleagues or family members. Sometimes a device may be used by several persons simultaneously, as when playing a multi-player game on a tablet. Occasionally, a device might fall into the hands of strangers.

In all these situations, it would be of great benefit for the device to know who is interacting with it and, occasionally, to authenticate the user. Users may want to limit access to age-appropriate games and media for children or prevent unauthorized or unwanted credit card charges. Users desire to hide sensitive personal information from strangers, colleagues, or curious family members. Or, users may simply want to enjoy an enhanced user experience from a multi-player game that can tell who touched the screen.

User identification and authentication mechanisms available on today's mobile electronic devices have been largely adopted from Personal Computer (“PC”) software and have not adapted to the versatility of the usage and sharing possibilitics. For example, several mobile devices (e.g., smart phones) do allow the user to restrict access to device functions. The devices, however, do not provide any easy way to quickly change, let alone authenticate, users. They typically provide Personal Identification Number (“PIN”) codes or passwords for authentication, although a number of other techniques have been proposed. Yet they remain cumbersome and very few people enable these security features on their phones.

There are several ways to authenticate a user, which in general can be divided into 1) what you know, 2) what you have, and 3) who you are. PINs, passwords and swipe patterns are the most widely spread authentication mechanism for mobile phones. These methods are easy to implement and require no special hardware, but are easily observable by an adversary and usually have very low information entropy. For example, the usual 4 bit numeric PINs used in most phones have a theoretical potential entropy of log₂(10⁴)=13.3 bits. Practical entropy for 4-digit PINs is likely to be much lower, as is the case with passwords. The second type of authentication mechanisms (“what you have”) are often also referred to as authentication tokens, examples include Magkey/Mickey, Radio Frequency Identification (“RFID”) or other wireless tokens such as transient authentication, and Infrared (“IR”) ring. Magkey and Mickey are tokens that use magnetic fields and acoustic signals that are received by the device's compass and microphone respectively. RFID, Near-Field Communications (“NFC”), and other wireless-based techniques are prone to eavesdropping and suffer from interference among multiple radio signal sources. And finally, IR ring demonstrated the possibility to use IR video cameras to authenticate users on a multi touch display, which is not directly applicable to today's mobile devices due to its additional hardware requirement.

Examples of “who you are” include iris recognition, face recognition, and voice recognition all of which are being actively prototyped and tested on mobile devices. Devices have been developed that include a finger print sensor and/or a finger-vein pattern matching technique. Both these techniques require specialized hardware which adds to the cost and form-factor of handheld devices and are prone to known vulnerabilities. On the other hand, face, iris, and voice recognition utilizes the in-built sensors and feature sets already implemented in mobile devices for other applications. While these techniques can leverage the abundance of past research in the respective fields, they also suffer from the well known spoofing mechanisms. For example, both high-quality photograph of the eye and printed contact lenses have been used to achieve close to 100% spoof acceptance rates for iris recognition systems. Face recognition systems can be compromised just by showing a picture taken with another smart phone. Similar results hold for face detection and voice detection although large strides are also being made for spoof detection in biometric authentication systems. More recently, innovative uses of the various sensors available in most smart phones have led to a number of unconventional techniques. For example, there are proposals for in-air gesture based authentication mechanism which uses the accelerometer sensors of the mobile device. Being easily visible to an adversary, such a scheme suffers from an unpleasant tradeoff between coming up with complex gestures and being susceptible to copy attacks, and can also be socially awkward. Implicit authentication is a similar approach which aims to authenticate mobile users based on everyday actions such as number/duration of calls, location, connectivity pattern, etc. and keeps a multi-variable continuous authentication score of the user. As is obvious, this requires a continuous modeling and logging of data from a variety of sensors and has a high energy cost.

Today's consumer electronic devices often include some form of parental control mechanisms, which are usually limited to locking out some functionalities of the device or service, e.g. adult content. Parental control mechanisms are an overlooked area of research, however, recent studies indicate that there would be demand for flexible access control mechanisms at home.

The problem of device pairing is also closely related to secure authentication and solution approaches often overlap. The general objective in this case is to enable two devices with no prior context to securely associate with each other in the presence of man-in-the-middle adversary. The short-range and frequency hopping nature of Bluetooth makes it a robust authentication mechanism, however several recent works expose a key vulnerability, i.e., passive sniffing of the PIN during the pairing process. Similarly, for NFC based pairing, eavesdropping using directional antennas has been shown to be a critical security threat. Novel use of the accelerometer sensor in mobile devices have recently been shown to provide a secure method of device pairing. While robust for two equipped mobile devices, the requirement of shaking prevents its use from cases which require pairing of a mobile device with a fixed device. Further, replication of the movement by an adversary is possible through careful observation of the pairing process. Finally, a recent approach uses public Radio Frequency (“RF”) signals such as Television (“TV”) and Frequency Modulation (“FM”) broadcasts to derive cryptographic keys for secure pairing between close-by devices.

Auxiliary channels to establish shared secrets have been studied extensively in the domain of secure pairing since the resurrecting duckling model. Examples include using infrared or humans. More recently secure pairing efforts have focused on using the same channel for authentication and data, and deriving the keying material based on the local environment.

While there are previous methods that help identify individual users through a token device, it is not clear that currently described options have operational efficiency and economy of design required in regular use. Therefore, there is a continued need for a through-touch-sensor low-energy communication method for token identification which is also energy efficient and long lasting.

### SUMMARY OF THE INVENTION

The present disclosure relates to data communications. More specifically, the present disclosure relates to the generation of touch events on a capacitive touch-screen of an electronic device to communicate information to the electronic device. A method, apparatus, and system for using a user device to communicate with a touch-screen of an electronic device involves the token transmitting its identity (ID) directly through the touch-sensor by artificially modifying the effective capacitance between the touch-sensor and token surfaces. The electronic device receives the signal to identify the individual token.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In one embodiment, the invention relates to a battery free token comprising a signal generating circuit, an energy harvesting module, an interactive device surface, and at least one electrode, wherein said electrode is electrically coupled to the circuit and configured to communicate signals from said signal generating circuit to said interactive device surface, wherein said signals comprises an arbitrary data sequence, wherein said energy harvesting module is electronically connected to said signal generating circuit and said interactive device surface. In one embodiment, said energy harvesting module comprises a storage capacitor connected to said electrode.

In one embodiment, the invention relates to a system for capacitive touch communication, the system comprising: a) a first device comprising a signal generating circuit, an energy harvesting module, a first device surface, and at least one electrode, wherein said electrode is electrically coupled to the circuit and configured to communicate signals from said signal generating circuit to said first device surface, wherein said energy harvesting module is electronically connected to said signal generating circuit and first device surface, and b) a second device comprising: a processor and a capacitive touch sensor surface; and a computer-readable storage medium storing instructions that, when executed, cause the processor to: receive a sequence of touch events from the touch sensor surface generated in response to the varying capacitance of the capacitive touch-screen caused by an external source; and identify the sequence of touch events as belonging to an unique external source, wherein said signal generating circuit is configured to modify the effective capacitance between said capacitive touch-sensor and said first device surface, wherein said modifying of said effective capacitance comprises a pattern, wherein said pattern comprises transmission of an arbitrary data sequence. In one embodiment, said modification of the effective capacitance between said first and second device comprises transmission of bits by emulating a series of contact/no-contact made on the capacitive touch sensor surface. In one embodiment, said rate of generation of touch events depends on the probe frequency of said capacitive touch sensor surface. In one embodiment, said energy harvesting module comprises a storage capacitor connected to said electrode, wherein said capacitor which absorbs voltage leak from said capacitive touch sensor surface when contacted with said electrode. In one embodiment, the system further comprises additional devices comprising a signal generating circuit, an energy harvesting module, a first device surface, and at least one electrode, wherein said electrode is electrically coupled to the circuit and configured to communicate signals from said signal generating circuit, wherein said signal generated is uniquely identifiable from other devices in said system. In one embodiment, said signal generating circuit comprises an electrical switch. In one embodiment, said electrode comprises a conductive surface. In one embodiment, the length of the data to be transmitted is greater than 10 bit. In one embodiment, said energy harvesting module comprises a band pass filter, a rectifier, and a capacitor in electronic communication with said electrode. In one embodiment, said first device communicates with said second device though the body of a system user. In one embodiment, said energy harvesting module is in electronic communication with the second device surface. In one embodiment, said first device communicates with said second device though the body of a system user. In one embodiment, the system further comprises a second electrode electrically coupled to the circuit configured to communicate the signal to the external device using a user's body as a communication medium, wherein the electrode is in contact with the user and the user is in contact with the capacitive touch screen. In one embodiment, a user employs the first device to communicate with a touch-sensor of the second device, the method comprising: generating, by the user device, a signal encoding a data sequence; communicating the signal from the user device, to the electronic device by varying a capacitance of the touch-screen thereof; and receiving and decoding, by the electronic device, the signal to obtain an identifiable data sequence.

Other objects, advantages, and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### Definitions

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used in this document, a statement that a device or system is “in electronic communication with” another device or system means that devices or systems are configured to send data, commands and/or queries to each other via a communications network. The network may be a wired or wireless network such as a local area network, a wide area network, an intranet, the Internet or another network.

A “computing device” refers to a computer, a processor and/or any other component, device or system that performs one or more operations according to one or more programming instructions.

The term “data” may refer to physical signals that indicate or include information. A “data bit” may refer to a single unit of data.

An “electronic device” refers to a device that includes an imaging device, a processor and tangible, computer-readable memory. The memory may contain programming instructions in the form of a software application that, when executed by the processor, causes the device to perform one or more barcode scanning operations according to the programming instructions. Examples of suitable devices include portable electronic devices such as smart phones, personal digital assistants, cameras, tablet devices, electronic readers, personal computers, media players, satellite navigation devices and the like.

This document discloses a form of “wireless” communication, called capacitive touch communication, to address the shortcomings of conventional devices and techniques. The key idea is to exploit the pervasive capacitive touch screen and touchpad input devices as receivers for an identification code transmitted by a hardware identification token. While the token can take many forms, one scenario disclosed herein is a token taking the form of a ring, inspired by the signet rings used since ancient times. The token transmits electrical signals on contact with the screen, either direct contact or indirect contact through the human skin. In contrast to the short comings of conventional devices and techniques, the present disclosure focuses on using arbitrary programmable sequences of bits through direct use of the user's fingers. As such, it makes the solution to those short comings non-intrusive and applicable to wider classes of applications. The present disclosure also facilities the use of parental controls in a similarly non-intrusive manner.

As used herein, the term “artifact” is used throughout the specification to describe a physical object to which a token may be physically or electronically connected.

### DESCRIPTION OF THE FIGURES

The accompanying figures, which are incorporated into and form a part of the specification, illustrate several embodiments of the present invention and, together with the description, serve to explain the principles of the invention. The figures are only for the purpose of illustrating a preferred embodiment of the invention and are not to be construed as limiting the invention.

FIG. 1 shows examples of new applications that require the association of artifact's identity to its touch interactions

FIG. 2a shows an overview of touch-sensing in a touch-screen device.

FIG. 2b shows the information flow of human touch event detection mechanism.

FIG. 3 shows one embodiment of a system overview diagram. An artifact is embedded with a token that communicates its ID to a touch-screen device by varying capacitance on the touch-sensing surface.

FIG. 4a&b shows the frequency distribution of the electrical signal captured from touch-screen surface of Samsung Galaxy. We placed an electrode on the surface of the touch screen and captured the electrical signal as a digital quantity on a microcontroller.

FIG. 5 shows an illustration of capacitance variations as a function of time.

FIG. 6 shows the signal and repeated component of sample devices.

FIG. 7 shows the result of auto-correlation calculation from the signal of Samsung Galaxy S6 and Samsung Galaxy S5.

FIG. 8 shows measured probe frequency of different touch-screen devices.

FIG. 9 shows the distribution of measured voltage of the electric field on touch-screen surface (left). The touch surface of a Samsung Galaxy S6 was virtually partitioned into grids and one measurement was taken for each grid, Power spectral density of the measured electric field across the touch surface (right).

FIG. 10 shows the power spectrum containing the peak power at 155 KHz (left), and corresponding power spectrum of the band-pass filtered signal (measurements for Samsung Galaxy S6) (right).

FIG. 11 shows a schematic of the touch energy harvester.

FIG. 12 shows the charging curve of harvested energy. 10BPF=10^{th} order bandpass filter, 50BPF=50^{th} order bandpass filter.

FIG. 13a shows a PCB design.

FIG. 13b shows a schematic of one embodiment of the invention token.

FIG. 14a-f shows an example set of developed prototypes: (FIG. 14a) a chess piece, (FIG. 14b) a 3D printed object, (FIG. 14c) a kid's toy, (FIG. 14d) a smart ring, and (FIG. 14e) a smart glove, and (FIG. 14f) a smart pen.

FIG. 15 shows power and current draw of each component in the token.

FIG. 16 shows comparison of energy consumption versus token ID data size.

FIG. 17 shows a prototype setup of Bluetooth Low Energy and NFC P2P.

FIG. 18 shows a touch event generation success rate on different devices.

FIG. 19 shows an object detection rate of the approach of the current invention.

FIG. 20 shows communication BER versus data size. Strawman uses a heuristic calibration mechanism along with touch based communication.

FIG. 21 shows An example workflow of performing two-factor authentication in a single step. Here, a passcode 0315 is being entered.

FIG. 22a&b show the user study results on 12 participants: (FIG. 22a) The summary of user rating on the technical idea, size, weight portability, easy to use, and overall; and (FIG. 22b) Learning time of users to use the token identification system.

### DESCRIPTION OF THE INVENTION

### 1. Previous Devices

Two references, U.S. patent application Ser. No. 13/853,899 [1], filed Mar. 29, 2013, (published Oct. 3, 2013); Provisional Patent Application 61/617,144 [2], filed Mar. 29, 2012, incorporated herein by reference, describe a version of a token-touch screen system, which requires a predetermined identifying information in both the token and the touch screen device. The difference here is that this reference does not describe the energy harvesting module or the method to generate a touch event as in the current invention.

Another reference, Vu, et al. (2012), Proceedings of MobiCom '12, 1-12 [3], describes the previous work with individual touch screen token systems. The reference describes both the direct and indirect contact method of interacting the tokens with the touchscreen. The reference describes a screen detection algorithm that causes the system to alternately register touch/no touch conditions even when the finger is not moving, which allows a token to send a digital signal into the touchscreen. This system is based upon a predetermined sequence from a specific token for identification. The system described herein does not describe the arbitrary data sequence via variation of the capacitance of the touch screen sensor or the touch screen energy harvesting module as described in the current invention.

Another reference, U.S. patent application Ser. No. 13/847,003 [4], describes an apparatus that can include a processor; a memory device in communication with the processor; a touchscreen operatively coupled to the processor, and circuitry to decode fields received via the touchscreen, the fields being modulated according to modulation codes associated with a set of tokens positionable on the touchscreen. The reference describes various types of tokens. An active token for a p-cap touchscreen may be configured to cause a known time-varying pattern in sensed capacitance, for example, by varying its capacitance, which may be added to a circuit as parasitic capacitance. Such an active token may be multi-state (e.g., and can switch states according to a code). The codes appear to be prearranged codes that are transmitted by time-varying pattern in sensed capacitance. The tokens may be associated with a particular set of instructions. In one example, the token modulates a field according to a modulation code that identifies the token. However, the system described herein does not describe the arbitrary data sequence via variation of the capacitance of the touch screen sensor or the touch screen energy harvesting module as described in the current invention.

Another reference, U.S. Pat. No. 9,041,668 [5], describes bidirectional communication between a mobile touch-generating device and a touchscreen device. The mobile touch-generating device is equipped with a detector system operatively coupled to the logic of the mobile touch-generating device, the touchscreen device includes an interface including a touchscreen, and the interface is adapted for communicating with the mobile touch-generating device. The method includes the steps of: issuing at least one instruction to emit a signal via said interface means; and receiving touch events via the touchscreen, the touch events being generated by the mobile touch-generating device. The codes emitted and received by the devices are predetermined. In one example the capacitance of the touch screen is modulated by the mobile touch-generating device. The prearranged codes enable identification of separate mobile touch-generating devices. However, the system described herein does not describe the arbitrary data sequence via variation of the capacitance of the touch screen sensor or the touch screen energy harvesting module as described in the current invention.

Another reference, U.S. Pat. No. 8,458,788 [6], describes a system for authenticating an input device subsystem for operation with a host. The input device subsystem is akin to a token. One method includes storing a table comprising challenges and a plurality of values indicative of authentic responses to the plurality of challenges. A selected challenge is then communicated between the input device subsystem and the host. A challenge response is derived based on the selected challenge and a hashing algorithm, and the challenge response is communicated between the input device subsystem and the host. The challenge response and one or more of the values is used to determine whether the challenge response is authentic. However, the system described herein does not describe the arbitrary data sequence via variation of the capacitance of the touch screen sensor or the touch screen energy harvesting module as described in the current invention.

Another reference, Kim, et al. (2015), Electron. Lett. 51(21), 1695-1697 [7], describes an fluorescent light energy harvesting method using a capacitive touch screen to charge a phone battery. This energy harvesting system uses noise on the capacitive touch screen to generate power. This reference does not describe the method of energy harvesting from the touch screen to power an interfacing token, but rather aim to harvest energy for the touch screen device itself.

Another reference, U.S. Pat. No. 8,278,571 [8], describes a system that allows for capactive touch interaction (such as fingers) and for simultaneous interaction with a separate device, such as a stylus, using electrode driving and sensing circuitry operably connected to the drive and sense electrodes and configured to permit at least some of the drive electrodes to be switchably configured thereby for operation as either drive electrodes in a first finger touch mode or as additional sense electrodes in a second active stylus mode. The mechanism described herein uses a separate mode of action to achieve identification of the stylus (could be viewed as a token). The reference also describes a version of the stylus that is configured to harvest electromagnetic energy from an in-range reader of the type employed in some RFID systems. This is also a different mechanism than described in the current invention.

Another reference, U.S. patent application Ser. No. 14/559,035 [9], describes a token scanning device includes a detection module configured for retrieving details from the information storage module, a motion tracking module for tracking a trajectory of the fiducial marker relative to the scanning device, and an authentication module for authenticating the token if the tracked trajectory matches sufficiently to a reference trajectory associated with the token. The reference also describes that the token could also include energy harvesting modules. The system described herein does not describe the arbitrary data sequence via variation of the capacitance of the touch screen sensor or the touch screen energy harvesting module as described in the current invention.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In one embodiment, the invention relates to the design and implementation of low-energy tokens for smart interaction with capacitive touch-enabled devices by associating the token's identity with its contact, or touch. While not limiting the current invention, in one embodiment the token's design features two key novel technical components: (1) a through-touch-sensor low-energy communication method for token identification and (2) a touch-sensor energy harvesting technique. In one embodiment, the communication mechanism involves the token transmitting its identity (ID) directly through the touch-sensor by artificially modifying the effective capacitance between the touch-sensor and token surfaces. It is believed that this approach consumes significantly low energy compared to traditional electrical signal modulation approaches. By enabling the token to harvest energy from the touch-screen surface the token is rendered battery-free. Through experimental evaluations using a prototype implementation, the one embodiment of the current intervention design is shown to achieve at least 95% identification accuracy. It is also shown to consume less energy than competitive techniques (NFC P2P and Bluetooth Low-Energy) for communicating a short ID sequence. The adoption of this technology among users has also been evaluated through a user-study on 12 subjects.

### 1 Introduction

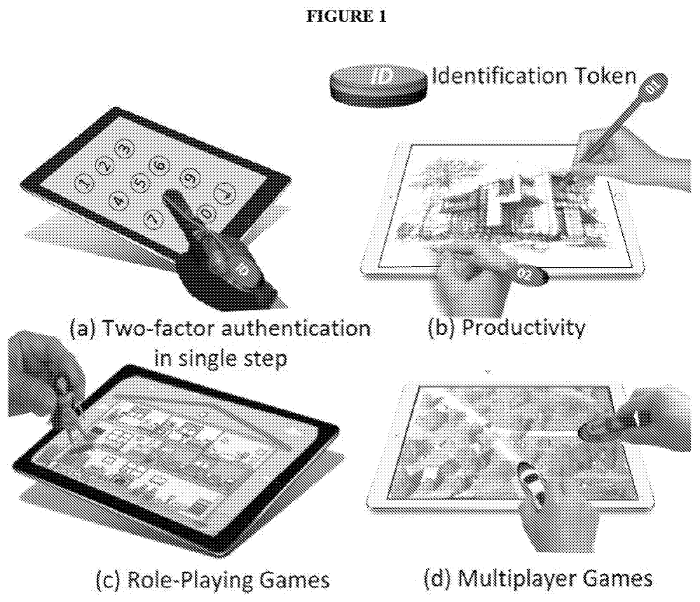

Human interaction with mobile devices through touch sensing has become the most common form of interaction ever since the inception of touch enabled mobile devices. Today, these interactions are being enriched with smart physical artifacts, or tokens. Yet, the possibility of advancing human-device interaction by associating identity of such tokens to the touch interactions has not been explored to the fullest. Associating identity to touch interactions enables new classes of applications on today's touch-enabled devices, as illustrated on FIG. 1. Non-limiting examples include wearable artifacts for user-authentication, smart tokens for multi-user gaming, or even for simultaneous multi-user collaboration for productivity. With technological advancements in 3D printing, designing and creating free-form tokens of various shapes and sizes to enable such applications have become easier than ever.

Association of identity to touch interactions requires reliable identification of the token on the touch sensing device. This primarily involves finding where exactly the token is placed on the touch-screen and what is the unique identity of that token. The touch-sensing firmware's API provided with today's touchscreen device operating systems (OS) allow for identifying the positions of any conducting material placed on the surface of the screen. However, this mechanism only allows to identify the positions where a token's conducting surface contacts the screen but not its identity.

One possible approach to token identification is to encode the identity as a unique physical pattern [10] which gets detected when the token makes contact with the touch surface. However, pattern detection will be highly error prone when the token is too small. Another approach [11] is to encode the identity (bits) as series of electrical pulses that trigger the capacitive touch sensing mechanism when the token contacts the surface. However, this mechanism requires significant amount of battery draw on the token, to generate electrical pulses with sufficient amplitude so as to be detected by the touch-sensor.

Motivated by the idea of communicating the token ID directly to the touch-screen device, the current invention addresses the token identification problem by leveraging the capacitive touch-sensing mechanism. This approach brings about two fundamental challenges: (a) designing a reliable communication link between the token and the capacitive touch sensor, and (b) minimizing energy consumption.

Low-Energy Token Identification.

The design challenges for token identification were addressed through two key aspects of the current invention system design: (i) a novel mechanism for communicating through the touch-sensor through capacitance variation, and (ii) a mechanism to harvest energy from the touch surface. In the capacitance variation based communication mechanism, the token transmits bits by emulating a series of contact/no-contact made on the touch-sensing surface. This process results in varying the effective capacitance between the token contact and touch-sensing device surface and get registered as “Press” (contact made) and “Release” (contact released), emulating the events when a human touches the screen. To minimize errors in detecting these events, and to allow for using the same tokens across different touch-sensing devices, a self-calibrating mechanism on the token is introduced to adapt its communication parameters specifically to the device it is communicating with. The contact/no-contact process on the token is generated by turning an electrical switch on the token ON or OFF based on the encoded bits. Controlling a switch requires a very small amount of energy. It is further minimized through an module that harvests energy from the touch-sensing surface.

The energy harvesting module design is based on observation that the touch sensing surface of devices have an electric field created on the surface. This electric field is a result of the scanning process of the touch-sensing module to detect human touch events by probing a monotone signal. Unlike other known harvesting techniques, RF [12], NFC [13]), or light [14], where the energy source availability on the touch-sensing device can be unpredictable, this electric field is always available on a device's touch-sensing surface when it is powered ON. To the best of current knowledge, this invention presents the first characterization of energy harvesting from a touch-sensor.

The following advancements are described:

(1) A system was designed to communicate information from tokens to touch-screens by varying the capacitance of the touch-sensing surface. A self-calibrating mechanism on the tokens was introduced to minimize identification errors on the touch-sensing device and adapt usage across different types of touch-screen devices.

(2) A method of harvesting energy from the touch-sensing surface is described. A touch-sensor harvesting component was designed and characterized.

(3) A prototype token hardware and implement the token identification system software on touch-screen devices is described. Multiple applications on these devices that can benefit from token identification were prototyped. A prototype touch-sensor energy harvesting module that can be integrated with the token was designed. While modifications to the touch sensor hardware and firmware can be made to facilitate such communication, the present invention will be described herein in relation to scenarios in which communications are achieved with off-the-shelf touch sensor systems. Embodiments of the present invention are not limited in this regard. Operating without physical layer access imposes stringent requirements on the communication protocols, as discussed below. The disclosed scenarios offer a useful point solution within the design space of capacitive touch communication, since this approach would allow more rapid deployment on existing devices. Although it is assumed that a developer will only have access to the touch events exported by the screen's driver, and not the raw voltage measurements, the disclosed scenarios are not so limited. One of skill in the art will recognize that the core features of the disclosed scenarios may be implemented with or without direct access to physical layer signaling from the capacitive touch screen.

(4) The energy consumption of the token was evaluated and compared with that of NFC and Bluetooth LE hardware tokens. The end-end application performance reliability using the system towards two use-case applications: (i) gaming token identification and (ii) user authentication was also studied. An user study to evaluate the acceptance of the invention design among human users was conducted.

### 2 Touch Sensing Background

Before delving into the details of the current invention touch based token identification system design, it is important to have an overview of the technical principles of the workings of a capacitive touch sensor pervasively integrated with touch-screen devices.

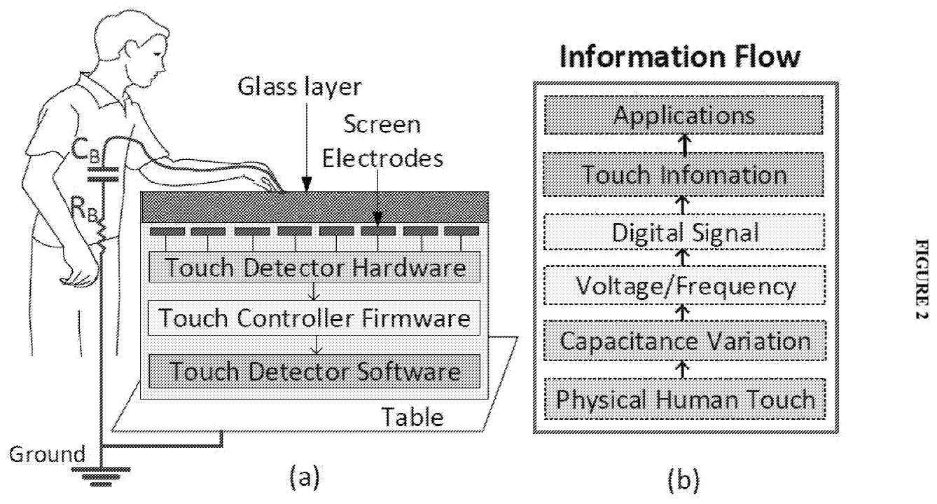

As depicted in FIG. 2(a), the touch-sensing module in touch-screen devices is typically composed of three key components: (i) touch-sensing hardware, (ii) touch controller firmware, and (iii) touch-detection software.

A touch detector hardware, including the touch sensor, is arranged underneath a protective and insulating layer such as glass, polymer, or plastic [15]. It comprises of the supporting circuitry to sense when a conducting material makes contact with the screen, or generates a touch. Touch-sensing can be accomplished using various technologies; for example, analog resistive [16], surface capacitive [17], surface acoustical wave [18], infrared optical technology [19]. Of this list, surface capacitive based touch sensing [20] has been the most prominent because of its low-energy consumption, high reliability, and low manufacturing cost. More than 92% touch-sensing devices shipped in 2014 is based on this technology and the number is predicted to rise to 98% by 2018 [21]. Thus the focus on surface capacitive based touch-sensing devices in this invention.

In a capacitive touch-sensing device, the touch controller firmware detects a touch by measuring the capacitance variation caused on the touch-sensing surface when a touch generates. The controller basically acts as an analog to digital converter that converts the detected capacitive variations to equivalent digital information to be processed by the touch detection software in the device's OS kernel.

The capacitance variation is measured by the controller using an active probing mechanism that periodically initiates an alternating current (AC) signal at frequency (f_{prob}). This probe signal is transmitted through the touch-sensor's electrodes and the differential voltage and frequency/phase of the signal reflected off the touch contact (e.g. human skin) is measured. If this differential is greater than a preset (calibrated) threshold, the controller records that a touch has been initiated by a conductive material pressing on the touch surface. When the difference is insignificant, the controller records that the touch has been released. In capacitive touch-sensing devices, a touch event is typically represented as a pair of “Press” and “Release” events.

The “Press” and “Release” events recorded by the controller are converted into equivalent digital information which is processed by the touch detection software in the device's operating system kernel and then forwarded to the application layer. This software module is essentially responsible for converting the digital signals into equivalent digital codes that are classified into different types of touch events; for example, the human finger tapping or swiping on the touch surface. The conversion from the human touch generation to the digital touch event registration is handled by an algorithm in this software module.

### 3 System Overview

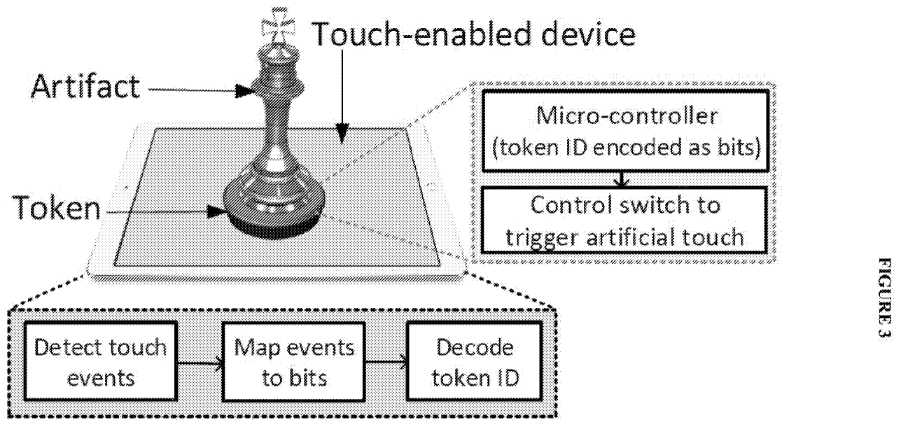

To allow the touch-enabled device to identify the artifact, it is proposed that the artifact would be equipped with a necessary hardware token to encode an ID (bit stream) into equivalent digital signals, that in turns would be used as an external trigger to artificially vary the capacitance between the token surface and touch-sensing module, as illustrated in FIG. 3. The capacitance variations would be detected as equivalent “Press and “Release” events that are processed as touch events by the touch-sensing mechanism on the device. The token ID is decoded through the supporting software on the device by analyzing the generated artificial touch events.

The key challenges in current invention approach are:
The artificial touch event triggering mechanism must work within the limited energy budget of the token.
The reliability of the touch event detection largely depends on knowledge of the probe frequency, without which the software will not be able to match the timing of the registered events with that of the touch events actually initiated.
Since the probe frequency may vary across different touch-screen devices, adaptation of the system to different devices becomes an additional challenge.

The challenges in designing a capacitive touch based token identification system are addressed by devising a novel low-energy and high reliability mechanism for communicating the token information to the touch-screen device. To further minimize the system's energy consumption, the possibility of rendering the token battery-free is explored by designing a module to harvest energy from touch-screen when the token is in contact with the screen and aim to channelize this energy towards the token identification process. The following provides an overview of the token identification and the energy harvesting aspects of the current invention system design.

3.1 Token Identification Through Capacitive Variations

A transmitter module is integrated on the token that translates information (e.g. ID) bits into a series of ON-OFF pulses using a microcontroller. The pulses control the ON-OFF states of a switch on the token which in turn controls the mechanical contact of the token's conductive surface on the touch-screen surface; ON implies the token is in contact and OFF implies it is not. This switching mechanism triggers capacitance variations between the conductive surface of a token and the touch-screen contact point creating artificial “Press” (ON state) and “Release” events (OFF state), which get registered as touch events by the touch-sensing mechanism on the device. This method of communicating bits by emulating the process of touch-event generation on a touch-screen device expends minimal energy on the token as the electric switch can be controlled with very low current draw from a battery.

The rate of generation of touch events depends on the probe frequency of the screen, f_{prob}. The reliability of the touch event detection largely depends on knowledge of this probe frequency. The rate of sampling the touch events (by the touch controller) on the device must have a deterministic relation with this probe frequency. If not, the software on the device will not be able to match the timing of the registered events with that of the touch events actually initiated, resulting in erroneous touch events. To address this issue, a self-calibrating mechanism is incorporate into the token that allows for automatically detecting this probe frequency when contacting the touch sensing surface of a touch-screen device. With the knowledge of this probe frequency, the token will be able to adapt the rate of generation of the “Press” and “Release” events such that the threshold for filtering out erroneously initiated touch events can be predicted on the touch-sensing device and thus minimize the errors in detecting the artificial touch events.

The token identification process involves two phases of operation:

(i) Self-Calibration phase, where the touch-screen is profiled for measuring probe frequency, f_{prob}, and the touch events generated by the capacitance variations are characterized as a function of this probe frequency. Based on the characterization, the effective sampling duration and detection thresholds for reliably detecting artificial touch events is estimated.

(ii) Sensing phase, where information encoded as bits is translated into equivalent capacitance variations to generate artificial touch events by the token, that are sensed by the touch-screen sensing mechanism on the device. The sensed touch events are decoded into equivalent information bits through software in the device.

3.2 Energy Harvesting from Touch-Screen

Based on an understanding of the touch-sensing mechanism, it was determined that the electrodes residing below the touch-screen surface periodically undergo a charging and discharging phenomenon to assist the scanning process to sense a touch. Through experimentation, the charge and discharging resulting in a small voltage leakage which resides on the screen's surface was observed. Based on this observation, a circuitry was designed to harvest this leakage voltage from the touch-screen to charge a storage capacitor. The energy stored in the capacitor will be used to power up the token when it makes contact with the screen. A key idea of the energy harvesting component design is to scan the touch-screen surface over a frequency range and filter the touch scanning frequency. Once the frequency is isolated, the current flow due to the leakage voltage is directed towards a capacitor using a rectifier. The energy harvesting component design is discussed in more detail in section 6 (the description of touch screen energy harvesting).

### 4 Self-Calibration Via Touch-Sensor Profiling

To reliably and effectively generate touch events, it is important for the token to operate with a proper configuration that fits with the touch sensor it communicating with. Since different touch sensor on the market has drastically different internal operating parameters (e.g. sampling rate, probing signal frequency, etc.), the token needs to be able to learn these key parameters, from which it will derive the proper configuration for event generation and communication. In practice, however, directly measuring these parameters from the surface of the touch device is challenging since it is not possible to get physical access to the touch sensors unless the device is cracked opened. In addition, this information is often not available from the devices datasheets. Even when it is available, the actual operating probe frequency of the device is often different from what specified by the manufacturer. A profiling method of the current invention is introduced to overcome this challenge.

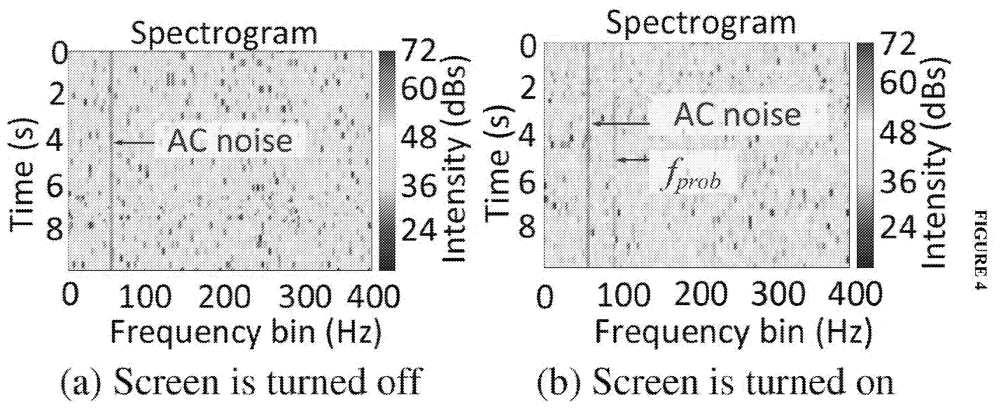

The profiling method of the current invention relics on the following intuition: since the capacitance variation is measured by the probe signal that creates an electric field on the touch surface, it might be possible to estimate the internal sensing parameters indirectly if one can capture the electric field generated by the probe signal. In addition, the probe frequency should be one of the frequency components of the electric field generated on the touch surface when it is switched ON. This intuition was confirmed through a feasibility experiment (FIG. 4a and FIG. 4b) where an electrode was placed on the surface of a tablet's touchscreen and analyzed the frequency distribution of the electrical signal on the surface. Shown in FIG. 4b, probe frequency can be clearly identified when the screen is ON proving that (1) the electric field can be captured with a single electrode and (2) the captured electric field signal contains internal sensing parameters of interest. This insight was used to develop a methodology to measure the probe frequency directly by token when it makes contact with the touch sensors surface.

4.1 Timing Characterization of Touch Sensing

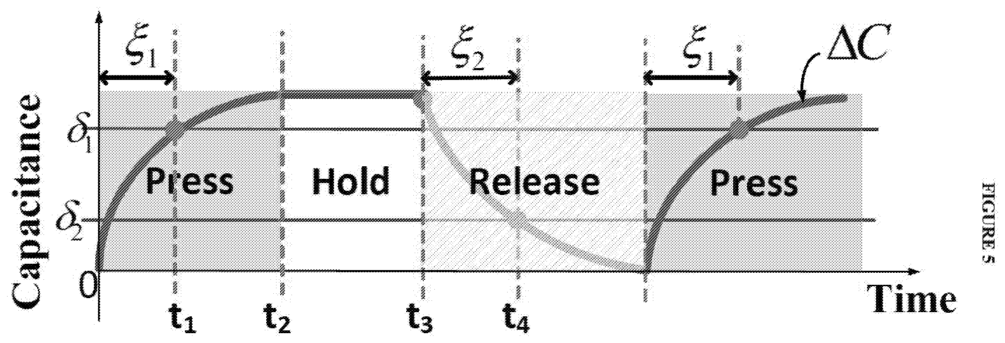

As mentioned earlier, the “Press” and “Release” events were used to represent and transmit data sequences. These events were first characterized by analyzing the charging and discharging behavior of the capacitance on the surface as illustrated in FIG. 5.

Let ΔC be the capacitance variation that the touch sensor observes. This variation is essentially the difference between the capacitance value between two temporal checkpoints (sensing duration), preset by the internal sensing algorithm. Upon a touch event initiation, the capacitance value increases as the charge accumulates, and the sensor detects a “Press” event when the measured ΔC is greater than threshold value δ₁ (at Time=t₁). The capacitance increases until it reaches a saturation point (at Time=t₂) and stays in a “Hold” state until the touch is released. When the touch is being released (at Time=t₃), the capacitance value gradually decays (discharging) and the sensor detects a “Release” event when ΔC<δ₂ (at Time=t₄). The capacitance continues to decay until it reaches the reference level (0) and stays in that state until the next touch event is triggered.

Therefore, the sensing duration of a touch event can be characterized by the timing duration of “Press” and “Release” events as in Equation 1,

Tₚᵣₑₛₛ=ξ₁+τ_{SS}

Tᵣₑₗₑₐₛₑ=ξ₂+τ_{SS} (1)

where, τ_{SS} is the propagation delay in conveying the sensed information from the sensor to the application layer through the touch device's software stack.

Here, δ₁ and δ₂ are the thresholds for detecting “Press” and “Release” events, respectively, and are preset by the device manufacturer. This implies that the value of the sensing durations ξ₁ and ξ₂ is not easily available and vary among devices depending on the touch sensor used, and thus have to be measured. Hence, in the current invention design, it is proposed to measure these sensing durations for each touch device through a one time self-calibration phase.

This timing characterization helps in designing the equivalent trigger pulse durations to generate the artificial “Press” and “Release” using the token. However, due to the unpredictable delay factor τ_{SS}, some of the touch events may be missed (not detected) by the sensing mechanism due to the timing mismatch of the token transmission rate and the touch sensor's sampling duration. If the sampling duration (or rate) of the touch sensor is known it will be possible to calibrate the token to the sensor's “Press” and “Release” sensing durations precisely. Knowledge of the sampling duration requires the measurement of the screen's probe frequency, f_{prob}.

4.2 Probe Frequency Estimation

Based on our preliminary feasibility experiment results in FIG. 4a and FIG. 4b, it was determined that it is possible to measure the probe frequency, f_{prob} directly from the touch sensors surface by analyzing the frequency spectrum of the electric field signal captured on the touch surface. However, performing frequency analysis on the token would consume a lot of energy and require a relatively powerful microprocessor. To mitigate this problem and minimize energy requirement, an alternative time-based technique was developed to extract the probe frequency by leveraging auto-correlation concept. The auto-correlation function (ACF) of the signal captured from the touch sensor surface was analyzed to identify the most time-repetitive signal component. This most repetitive component is the probe signal. Its length in time domain is equal to the distance from the first peak to the second peak of the ACF (period p); the frequency f_{prob} is computed as f_{prob}=1/p.

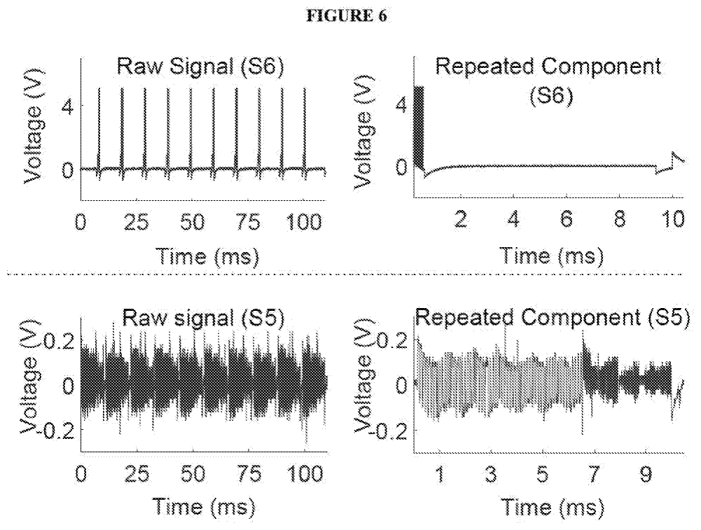

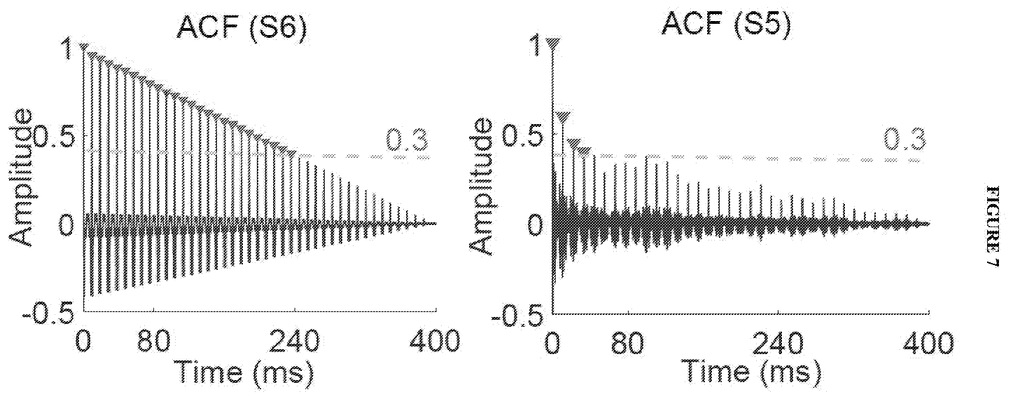

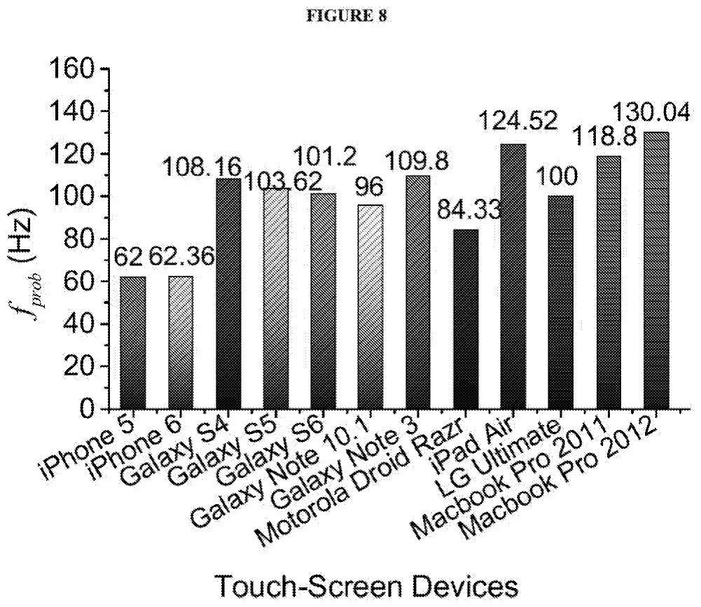

FIG. 6 shows the time series of electric field signal captured on the touch surface of Samsung Galaxy S6 and S5, in which a repetitive pattern of the probing signal can be clearly identified. Their corresponding ACFs are shown in FIG. 7; here a threshold value of 0.3 was used to terminate the ACF computation. The selection of the threshold only impacts the running time of this one-time self-calibration process but not the accuracy of f_{prob}, estimation. To empirically validate the algorithm, the self-calibration was performed on 12 other devices, with results reported in FIG. 8. In the course of this profiling experiment, the execution time of this one-time calibration process was also measured to be about 4 seconds, which is the total time taken for the token to determine f_{prob} from the time it makes contact with the screen.

### 5 Sensing Token's ID Through its Contact

In this section, the algorithm designs are described that allow a token to represent its ID through a time series of capacitance variations. How the touch-enabled device decodes the tokens ID from the series of touch events generated by such capacitance variation sequence is shown. The mechanisms are discussed using a working example of Samsung Galaxy SS5 device.

5.1 Representing Data Through Capacitance Variations

As explained earlier, the current invention token can create artificial “Press” and “Release” events on the touch device by varying its capacitance when they are in physical contact. The arrival time information of these events (on the device) is studied to help design a data structure for information transmission. In the following discussion, it is shown how the token represents bit ones and bit zeros by controlling the timing information of the “Press” and “Release” events.

Pulse width modulation (PWM) is used to represent the data sequence. Specifically, a bit one is represented by a “Press” event followed by a “Release” event that are Tₒₙₑ milliseconds apart. Likewise, a bit zero is represented by a “Press” event followed by a “Release” event that are T_{zero} milliseconds apart (Tₒₙₑ must be different from T_{zero}). This means that the token needs to close the switch to vary its capacitance and hold the switch at the close position for Tₒₙₑ milliseconds in order to indicate to the receiver that it wants to transmit bit one. The holding time will be T_{zero} milliseconds if bit zero needs to be transmitted. The challenge here is determination of these two time constants.

From a data rate perspective, it is intuitive that smaller time constants are desirable as it will yield a higher data rate. However, if these two time constants are too small, the touch sensors cannot respond fast enough to register correspondingly generated events. Specifically, if the two time constants are smaller than the probe period (1/f_{prob}), the event will be missed by the touch controller as it would not have been sampled. In addition, it is noted that there is a variable delay from the moment that the token toggles its switch (i.e. open or close) until a corresponding event is registered and delivered to the application layer of the touch-enabled device. This variable delay is captured in τ_{SS}: consolidation of the queuing and propagation delays in conveying the sensed information from the sensor to the application layer through the touch device's software stack. Therefore, the token needs to select Tₒₙₑ and T_{zero} in such a way that such variation does not confuse the corresponding pulse width demodulation deployed in the software receiver on the touch-enabled device. Lastly, if the two time constants are too high, the system can operate only at very low data rate. It is proposed to determine Tₒₙₑ and T_{zero} as follows in Equation 2:

Tₒₙₑ=2×(1/f_{prob})+Max(τ_{SS});T_{zero}=Tₒₙₑ+(1/f_{prob}) (2)

in which 1/f_{prob} is measured from the self-calibration step and Max(τ_{SS}) is conservatively assigned to be 2 ms; note that OS-based propagation delay are typically smaller than 1 ms in almost all modern OS's.

A fixed-length payload is packed into a data frame that has [pre fix∥data∥suffix] format. The pre fix is used as pilot symbols while the suffix contains the parity check together with the frame ending indicator. A silence period of 3×1/f_{prob} is used for frame ending indication.

5.2 Decoding Transmitted Data

The decoding process relies on the duration between a pair of “Press” and “Release” events to retrieve each communicated bit and then reconstructs the originally transmitted payload data frame. However, the key challenge here is the fact that the receiver software is not aware of what values of Tₒₙₑ and T_{zero} are being used by the transmitting token. In this regard, a self-calibration method was incorporated to determine a threshold γ to help the decoding mechanism identify whether a received duration represents a 1 or 0. To identify γ, the calibration process works as follow. The token sends a 100 bit sequence of alternating 1s and 0s. Based on the received series of events, the decoder finds a threshold γ which can be used to reconstruct the bit sequence. Once the threshold is calculated, the demodulation is straightforward. One possible realization of the threshold selection is described in Algorithm 1.

| | Algorithm 1: Finding threshold (γ) in time arrival for | | |
|---|---|---|---|
| | differentiating touches representing bits 1s and 0s | | |
| | input : E_{discrete} - Event sequence in time domain | | |
| | TrBitSeq - Transmitted bit sequence 1^{l}0^{l} | | |
| | output: γ | | |
| 1 | Extract the type of events: Eₚ is the set of press events | | |
| | and Eᵣ is the set of release events. | | |
| 2 | /* Find the press delay of all emulated touches (Γ)*/ | | |
| 3 | for j = 1→ (max(E_{discrete})/2) do | | |
| 4 | └ | Γ[j]←Eᵣ(j) − Eₚ(j) | |
| 5 | /* Check the number of received events */ | | |
| 6 | if \|Eₚ\|≠\|Eᵣ\| OR \|Eₚ\|≠\|TrBitSeq\| OR | | |
| | \|Eᵣ\|≠\|TrBitSeq\| then δ←NULL | | |
| 7 | else | | |
| 8 | \| | for k = 1→max Γ do | |
| 9 | \| | \| | if TrBitSeq(k) = = 1 then Γ₁ = Γ₁ U Γ(k) |
| 10 | \|_ | \|_ | else Γ₀ = Γ₀ U Γ(k) |

| | |
|---|---|
| 11 | /* Find the threshold */ |
| 12 | if ∃temp, max Γ₁ < temp < min Γ₀ then γ temp |
| 13 | else γ←NULL |
| 14 | return γ; |

### 6 Touch Screen Energy Harvesting

The scanning mechanism of the touch-sensing module to detect touch events creates an electric field on the touch-screen surface. The availability of this electric field in contact range of the token opens up the possibility of harvesting this indirect energy source by using it as a voltage source to drive the token, thus rendering it battery-free.

6.1 Touch-Screen as a Voltage Source

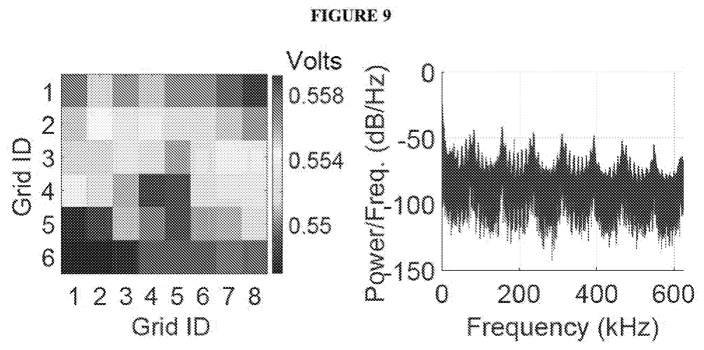

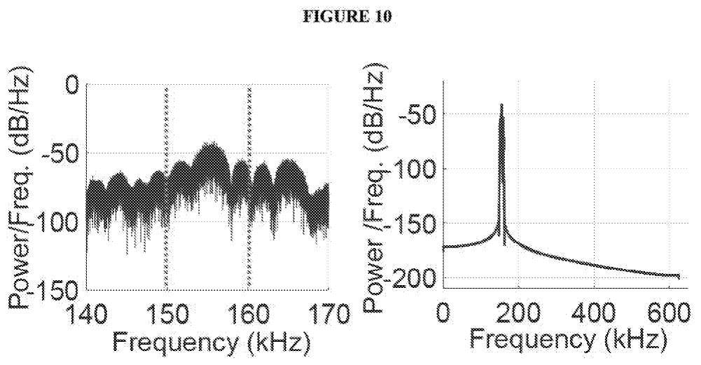

An experiment was conducted where a conductive material was attached on the contact surface of the token, and the electric field on the touch-screen surface was profiled for its voltage (will refer to as leakage voltage) and frequency spectrum. It can be inferred from FIG. 9 (left) that the leakage voltage is almost uniform across the surface. However, it was observed from FIG. 9 (right) that the frequency distribution is spread across a band. Thus, isolating the frequency corresponding to the AC leakage voltage source is necessary.

As the touch-screen energy source is at physical contact distance, the path-loss is almost zero. Hence, it was determined that the peak in the power spectrum will be dominated by the leakage voltage signal. FIG. 9 (left) and (right) show frequency band where the peak lies and the bandpass filtered spectrum, respectively. In this way, a touch-screen is characterized as an AC voltage source with certain peak-voltage and source frequency.

6.2 Energy Harvesting Component Design

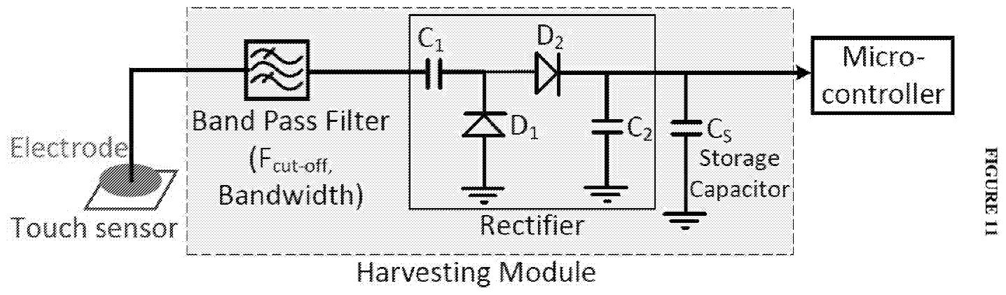

Treating the touch-screen as a voltage source, we design a hardware module for harvesting energy from the touch-screen surface. This module can be integrated with the token by wiring it in series the conductive surface of the token. The key components of this module include a bandpass filter, a rectifier, and a capacitor to store the harvest energy; a schematic of the module is shown in FIG. 11. The band pass filter isolates the peak signal frequency. The rectifier functions as a half-wave voltage rectifier. It includes a Schottky diode which operates much faster than traditional diode due to its non-linear operation, which provides a large forward voltage differential and a large forward current (of the order of 100s of mA).

6.3 Use-Case Analysis

Considering the Samsung Galaxy S6 use-case, we design a harvesting module that uses a 10^{th} order Butterworth Band-Pass Filter (BPF) with center frequency of 155 KHz and the lower and upper cut-off frequencies of 150 KHz and 160 KHz, respectively. The cutoff range can be determined during the one-time calibration phase of the system. An Avago HSMS-285C [22] Schottky diode was used, which created a voltage differential of 150 mV with 100 mA forwarding current during harvesting. A 470 μF 5V capacitor was used as the energy sink, whose value is calculated for matching the peak signal frequency. Powering the token mainly requires powering up the microcontroller and the relay switch (to trigger pulses that initiate capacitance variations), which requires at least a supply voltage of 1.8V. At this voltage, the generated forward current is 100 mA. It was determined that the forward current required to generate 1 bit on the token is about 10 mA, thus the harvested module can generate about 10 bits once powered up from a cold start.

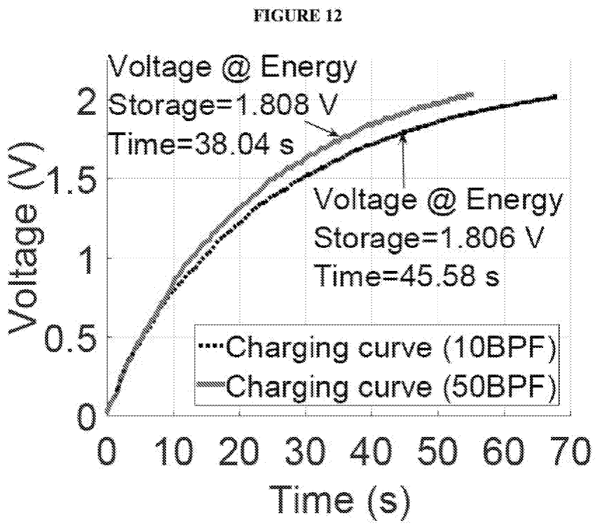

Based on the charging graph of the storage capacitor during harvesting, as shown in FIG. 12, it takes about 45 seconds to charge up to 1.8V from cold start; this can be reduced to 38 sec using a higher order bandpass filter. Note that this duration is the time the system requires to power up the token circuitry from zero supply voltage and zero residual charge. During operation it is proposed to keep the token at this minimum supply voltage even during idle modes. Since the harvesting and the token identification process can happen in parallel, effectively, the token operation can be rendered battery-free.

### 7 Prototype Implementation

A prototype hardware token was created and the software implemented for token identification using smartphone and tablet touch-screen devices as a running examples.

Hardware Prototype for Identification Token.

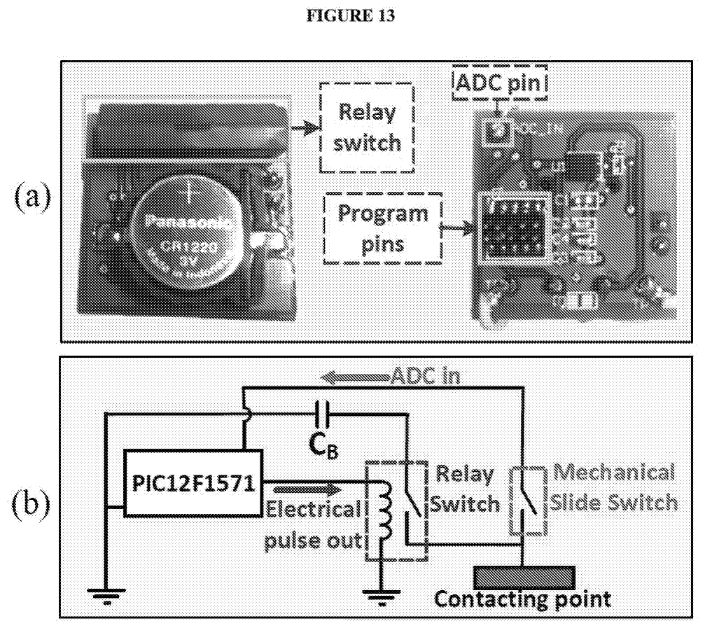

The schematic and printed circuit board of one embodiment of the current invention is shown in FIG. 13a and FIG. 13b, respectively. The token consists of a microcontroller PIC12F1571 [23] with a flash memory unit. The microcontroller is programmed to generate ON/OFF electrical pulses corresponding to the 1s/0s of the token ID bit stream. These pulses open and close a Reed relay switch [24]. The switching process varies the capacitance of the token's contact point with the touch surface by connecting and disconnecting the contact point through a 100 μF capacitor.

A mechanical slide switch is provided on the token to allow toggling between two operating modes: calibration or communication. In the calibration mode, the token conducts the one-time probe frequency profiling procedure if registering with the touch-sensing device for the first time. During subsequent operations this mode involves the token self-calibrating its transmission rate based on the probe frequency and sampling rate of the touch-sensing device. The token software (electrical pulse generation, CRC computation, pilot and header generation, and parameter extraction) has been developed on MPLAB X IDE development platform in C language.

In one embodiment, a coin cell (3V) battery was used to power the token when the harvesting module is detached. This also serves as a backup power source during the calibration phase. The size of one embodiment of the current invention token prototype is 4 cm² (negligible thickness). It is believed that it is possible to reduce the form factor using surface mounted components in future designs.

Software on Touch Devices.

The software modules for token identification was implemented as individual apps on Android OS enabled touch-screen devices. The apps are set to detect “Press” and “Release” events using the MotionEvent class [25] from the touch-sensing API provided in Android. The class helps to extract the event time and touchtype which are the key parameters used to map the detected touch events into bits.

Augmenting Physical Artifacts.

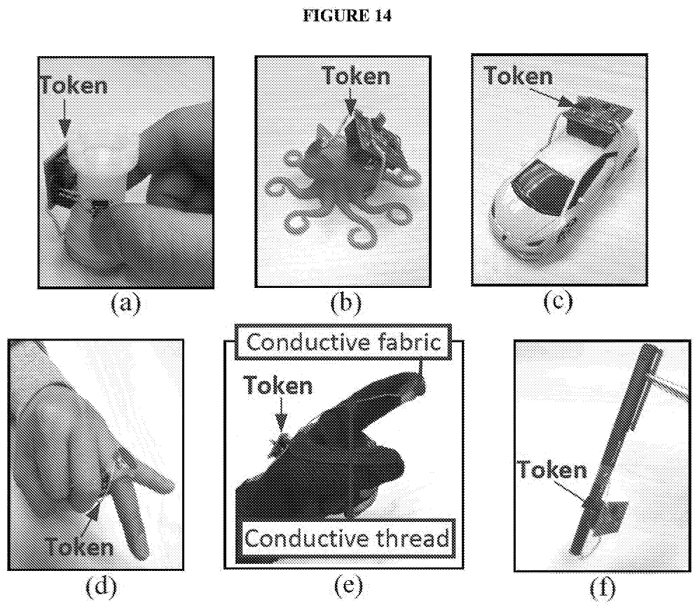

The token was integrated with real world artifacts as shown in FIG. 14a-f.

Smart 3D printed artifacts. a token was integrated with 3D printed artifacts that includes a gaming artifacts (FIG. 14a-c) and a wearable ring (FIG. 14d). The token was attached to these artifacts with the token's contact surface facing out. The chess piece and the ring tokens were used towards evaluating a prototype object identification application.

Smart Glove.

A smart glove contraption was created that can be identified by a touch-screen device, by augmenting a commodity fabric glove (Mechanix [26]) with the token. The finger tip on the glove was covered with a conductive material which was wired to the contact point of the token using a low impedance conductive thread (annotated in FIG. 14e). This prototype was used to evaluate the reliability of a prototype two-factor authentication application for touch-screen devices.

Smart Stylus (Pen).

A smart stylus contraption was created by connecting the tip of the stylus to the output of the token. This augmentation enables the supporting application on the touch-screen device to associate every touch of the stylus on the screen surface with its associated ID. This feature can help provide multi-user support for collaborative working applications as well as multi-user gaming.

### 8 Evaluation

Experiments were conducted to evaluate the energy consumption and identification reliability of our token identification system. In particular the following were evaluated:

(i) Token energy consumption per identification attempt, and compared with NFC and Bluetooth tokens.

(ii) Bit error rate (BER) of proposed communication mechanism.

(iii) End-End application performance for prototype apps: (a) object identification through touch, and (b) two-factor authentication in a single step.

(iv) User study evaluation.

8.1 Energy Consumed Per Identification

The energy consumption of the token identification system includes that of the token and the touch-sensing device. The energy consumption on the token was evaluated and compared with competitive token identification technologies.

8.1.1 Energy Consumption of Our Token

The energy consumption of the token includes that of the micro controller and relay switch. The energy consumption can be expressed analytically as follows in Equation 3,

E=U×(I_{relay}+I_{mc})×L/f (3)

where I_{relay} is the forward current to drive the relay switch, U is the supply voltage, I_{mc} is the current draw by the micro controller, L is the token ID data size, and f is the data rate.

The micro-controller from Microchip can operated in an extreme low power mode at 0.03 mA/MHz with supply of 1.8V [23]. The OMRON relay(G3VM-AYX/@DYX) [27], draws mA forward current at 1.63V forward voltage. Based on the calibration, the sampling duration on a Samsung Galaxy S5 must be minimum at Δt=Δs=12 ms; implies the capacitance variation technique requires ((1000 (ms)×2)/(T_{bit1}+T_{bit0}))=30 ms for 16 bits data size. Therefore an effective data rate of 33.3 bits/s can be achieved. The transmission duration for 16 bits is measured to be 0.48 seconds. Therefore, the energy consumption is E=1.8×(10+0:03 mA)×0.48=8.6 mJ.

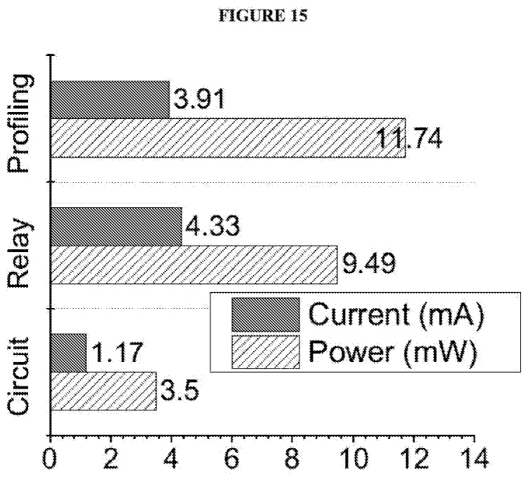

The average power and current draw (FIG. 15) from the coin cell battery for each component (profiling, relay and circuit) of the token was measured when transmitting a series of 1s and 0s for 0.2 seconds. The average power consumption of transmission (profiling is done apriori) is 12.99 mW for a duration of 0.2 sec at an average current draw of 5 mA.

8.12 Comparative Evaluation

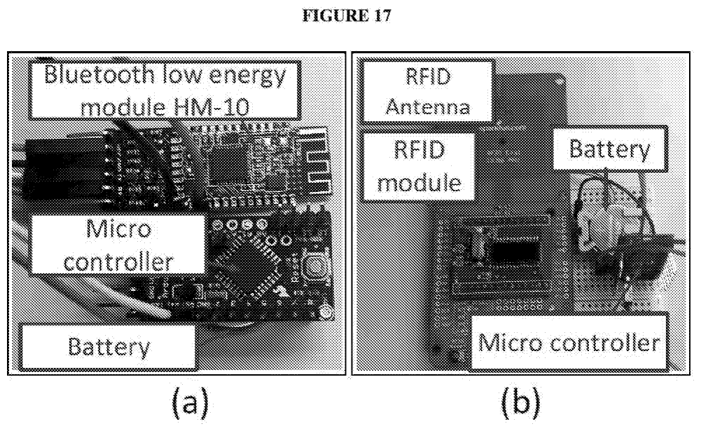

A Bluetooth BLE and NFC P2P token implementations were created as shown in FIG. 17. The BLE token uses a low energy HM-10 module [28], driven by an Arduino Pro Mini [29] to transmit an ID decoded by the BLE module of an Android device. The NFC token uses a Sparkfun RFID module [30] for communication controlled by an Arduino. A host-based card emulation was setup on Android to receive the ID transmitted from the NFC module. The energy consumption was measured for each identification attempt (transmit and decode by Android device) using a Monsoon power monitor [31].

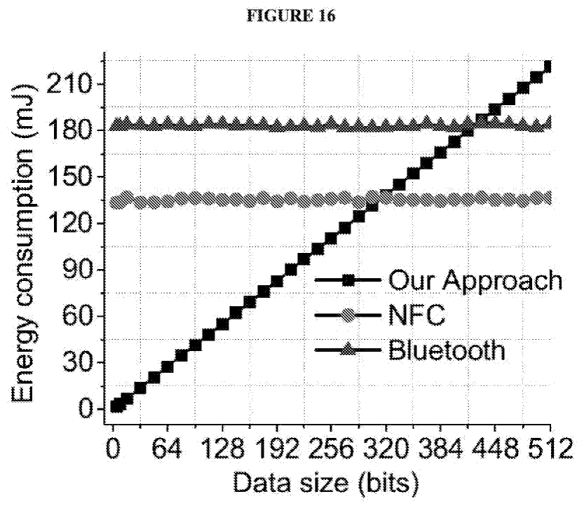

The token's energy consumption per identification for different token ID sizes is reported in FIG. 16. It is observed that the token energy consumption is linearly proportional to the ID size and also it monotonically increases at a significantly faster rate than BLE and NFC. However, the current invention token consumes less energy than NFC and BLE at small data payload sizes; crossover occurs at 304 and 416 bits, respectively.

Both, BLE and NFC have high initialization overhead, compared to the current invention approach, due to pairing and waking up from idle mode. However, BLE and NFC have much higher data transmission rates (2.1 Mbit/s and 424 kbits/s, respectively) compared to the current invention approach (40 bps), and that the overhead only incurs only one time per identification, the benefit amortizes as the ID length increases. Therefore, NFC and BLE outperform the current invention approach when the ID length precisely exceeds 304, 416 respectively. It is noted that a large number of identification applications [32] typically consider 128 bit IDs, in which case the current invention system can outperform BLE and NFC. It is also observed through the current invention measurements that the idle mode (token is ON but no transmissions) energy consumption of the current invention token (3.35 mW) is at least 10× energy efficient than BLE (44.49 mW) and NFC (60.54 mW) tokens.

Meanwhile, state-of-the-art technique for generating the touch [33] to the screen uses 9V voltage and inject to the screen continuously at the data rate of 4 bits/s. Given the requirement of transmitting 16 bits of data, the Capacitive Touch Communication (CTC [33]) technique, which operates at 4 bits/s, consumes 1800 mJ of energy. The energy consumption of CTC is about two orders of magnitude larger than the current invention approach as the former requires a 9V signal injection into the screen, which drains a lot of battery power merely to generate this signal.

8.2 Benefits of Self-Calibration

As discussed earlier the self-calibration through touch-screen profiling stage is the key factor in minimizing the energy consumption of artificial touch generation. This process also helps in achieving high communication reliability. This reliability Bit Error Rate (BER) metric was evaluated.

Recall that the self-calibration is done through a profiling step in which the token extracts key parameters that characterize the touch-sensing mechanism; its detection frequency, charging and discharging times, and touch event propagation time. Without this step, the token must make a heuristic approximation about what communication parameters are best suited for interacting with the particular touch-sensing device.

Strawman Approach. Let one consider a strawman example for a heuristic that determines the communication parameters. Let one consider that the sensor's detection frequency, fᵣ is the same as the screen's refreshing rate. For example, Samsung S6 devices feature the CapSense touch controller which operates at 120 Hz refreshing rate [34]. This implies that the token must be configured to generate capacitance variations (at sampling rate fₓ) at a rate of at least 120 Hz. Let one fix the charging and discharging durations, ξ₁; ξ₂, at 2 ms based on an empirical estimations through measurements.

In the touch sensing module, the bit detection errors (thus BER) will be ideally zero if the number of events sensed by the touch device is exactly equal to the number of events intentionally generated by the token. Therefore, the success rate of detecting the token generated touch events—the ratio between the number of events that the touch sensor receives and the total number of events that are generated by the token—defines the BER curve.

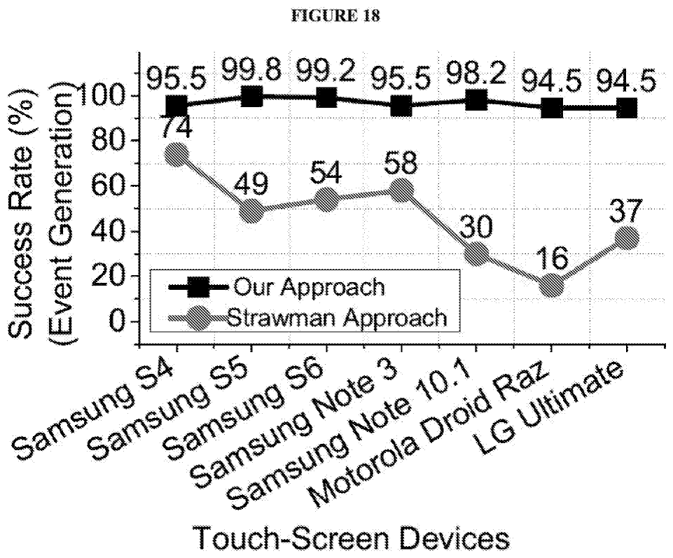

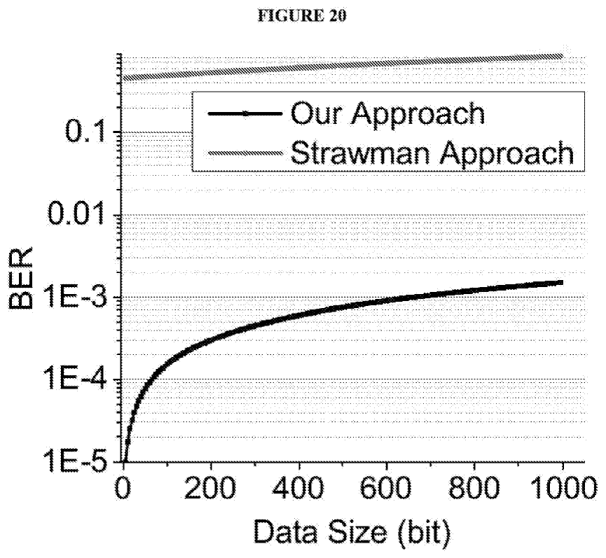

In FIG. 18, the success rate of event generation on the token is shown, over 10³ events for 7 touch-enabled devices. It is observed that self-calibration helps in generating touch events on the token with high reliability, significantly higher (about 6× in best case) than the strawman approach. A significant difference (3-4 orders of magnitude) was observed in BER of the current invention system compared to the strawman as shown in FIG. 20. The experiment confirms that the use of the current invention profiling based self-calibration approach can significantly outperform heuristic approximation through empirical measurements for touch based communication.

8.3 Application-Based Evaluation

The current invention system was evaluated using two types of applications. The ability of the current invention to associate a token's ID to its touches, and also evaluate the performance of a novel application that allows for 2-factor user authentication in a single step is discussed.

8.3.1 Object Identification Through its Touches 3D printed artifacts (5 artifacts as illustrated in Section 7) were attached with a token of 64 bit ID size and transmission rate of 30-46 bps; depending on its self-calibration output. The pre-installed software was customized for the application on the touch-screen device to identify the token. The experiment was conducted by testing the token identification over different locations on the touch-screen, repeated over 400 trials and tested on 7 touch-screen devices.

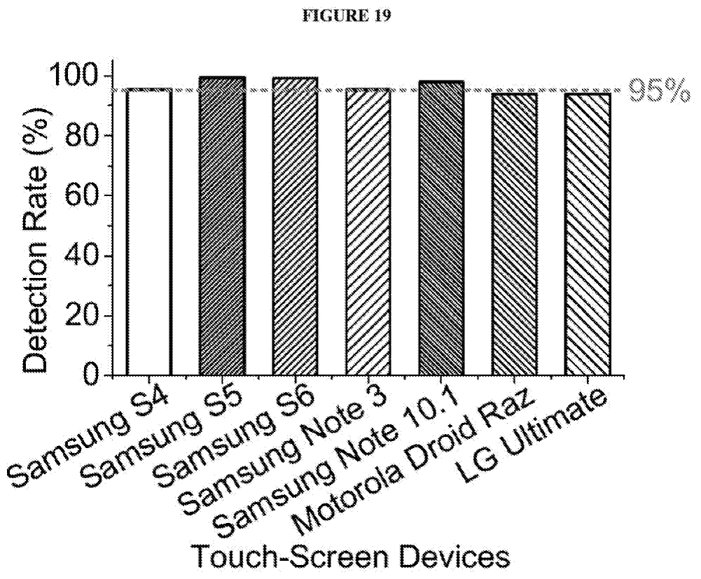

FIG. 19 reports the object identification accuracy through the token detection rate (fraction of total number of times the token is correctly identified). It was observed that it is possible to identify objects with at least 95%. A negligible false detection rate in the experiment was observed. However, it is believed that the false detection rate may become non-zero, as the number of trials increase, yet stay low due to the self-calibration process.

8.3.2 Two-Factor Authentication in Single Step

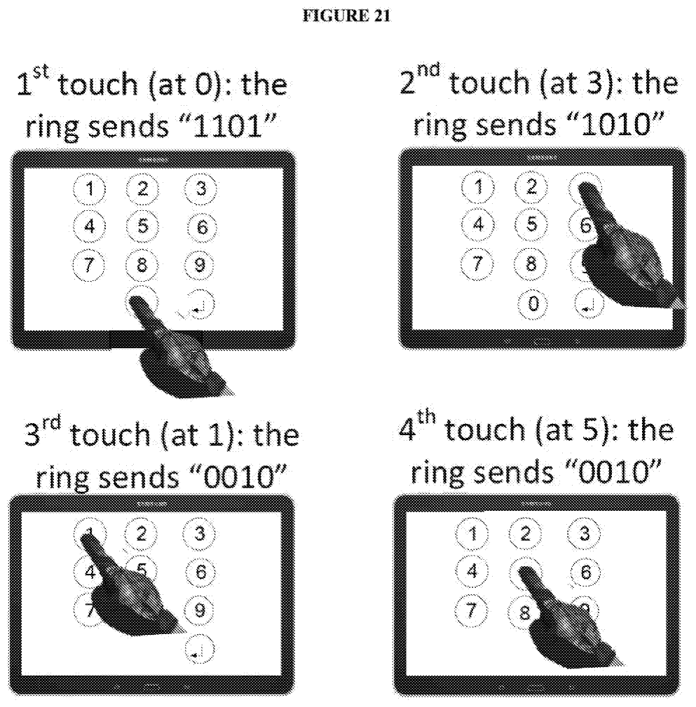

Use-Case Definition. When a token is worn by a user, such as in a smart glove, two-factor authentication in single step can be enabled. In this application, a user can perform two-factor authentication through a single step process of typing in a password/passcode. When the user touches an alphanumerical on the screen with the smart glove, the token simultaneously transfers the corresponding part of its ID simultaneously. By the time that the user finishes entering the password, the token ID transmission is also completed. This method of authentication eliminates the need to carry multiple physical entities corresponding to each authentication factor as in traditional 2-factor authentication (e.g. password and smartcard). FIG. 21 shows an example of two-factor authentication in which the pass code contains 4 digits 0, 3, 5, and 1 and the authorized token ID is “1101 1010 0010 0010”. The application allows user to access the device only if the correct pass code is entered and when the token ID is identified correctly.

Detection Rate. A 16 bit token ID was used for evaluation of this application. The experiment of typing in a 16 bit equivalent password (4 characters) was conducted; example in FIG. 21) and repeat the same for 100 trials. A 92% password identification accuracy (token ID identified) was observed. It is suspected that the 8 incorrect cases were caused by the users' typing habits; for example, the finger is lifted from the screen after each touch before the bit sequence gets successfully transmitted. The impact of such user behaviors was confirmed through the user-study to be discussed ahead.

Authentication Time.

The time that it takes for user authentication is comparable to that of NFC and BLE systems. The BLE and NFC P2P approach take about 3 seconds to complete wake up, pairing, and communicating the ID. The dominant time factor in the current invention technique is not from the ID communication process but from the user's typing behavior. For example, for communicating 1 character (4 bit sequence) on each touch, the current invention communication technique on a Samsung Galaxy S6 phone takes 121 ms which is less than a half of typical typing durations (250 ms).

Discussion on Security Level. A common 4 digit PIN pass code on Android or iOS has maximum 13 bit entropy (10⁴≈2¹³. A n-character password on iOS has maximum 6.27n bit entropy (77ⁿ≈2^{6.27n}). Android pattern lock is estimated to be 19 bit entropy (2¹⁹) [35]. The proposed two-factor approach can significantly improve the security level of password based authentication systems as it requires a physical token for authentication. It has 3×m×n bit entropy (i.e. 2^{3×m×n} possible combinations) in which n is the ID length and the passcode is of length m with each digit in [0-9]. The security levels would be increased further if ASCII passcodes are used.

8.4 User Study

An user study was conducted to evaluate the readiness of users to adopt the current invention technology.

Setup. The study was conducted using 12 participants (seven males and five females) whose within the age group of 18 to 44 years. The participants were all graduate and undergraduate students from computer science and electrical engineering majors. An IRB for the study was approved and qualified for minimum risk exemption. Participants were briefed for 10 minutes about the ID tokens and the underlying technology. This introduction also included demonstration of how to use the ID tokens for object identification and user authentication purposes. Two types of prototypes were presented to each participant: a smart glove for two-factor authentication in single step (one for each hand) and a chess piece for on-touch-screen gaming application (quantity=3).

Study procedure. After the introduction session, participants were provided with the tokens and directed to use them towards the identification and authentication applications. For each participant, the duration it took each user to confirm (verbally) that they are comfortable with the token usage setup was recorded; this is referred to as learning time. At the end of the study, each participant was provided with a survey form. The survey contained questions that asked users to grade their interest on the current prototypes from 1-10, with 10 being excellent. The ratings were garnered for the idea, size, weight, portability, ease of use, and overall rating. Participants were queried regarding their opinions are about the strengths and weaknesses of the current token; and what was needed to improve to make better tokens.

Survey Results.

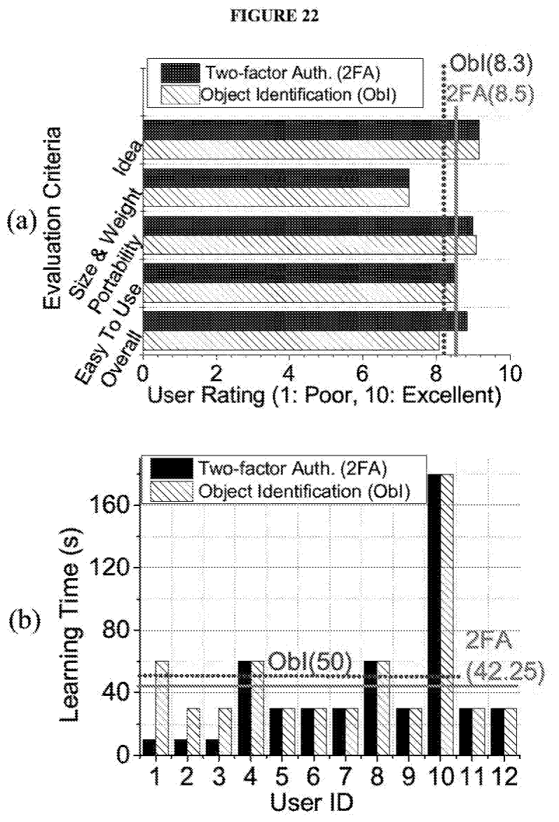

FIG. 22a summarizes the users' responses on the survey, and FIG. 22b summarizes the learning time of users. Most users require very little time (about 40-50 sec on average) to familiarize with the tokens. Users were typically very positive about the usage of this technology and appreciated its convenience and fundamental idea as a whole.

Participant Distribution and Behavior.

The results from the study could have a small bias factor as the participants' background is in either computer science or electrical engineering. However, the participants did not have any prior knowledge about the current invention technology. During the study, it was observed that most of them tinkered around with the token for about halfhour when the study supervisor left the room after introduction session.

Other feedback from users. Some extra feedback about the current system was obtained in terms of remarks and questions from users.

(i) “For two-factor authentication tokens, thieves might recognize users if the token is conspicuous. This can push the users into an unsafe situation.”; (ii) “I don't like to wear a ring or gloves for authentication”; “I would love to have my bio-mctric parameter embedded into the pairing code so that I can be exclusive user of the token.”.

The response for these remarks and questions is that the current invention tokens are currently in prototype phase. It is believed one embodiment of the current invention is miniaturized version of these tokens and in one embodiment the tokens can be inconspicuously embedded into daily usage accessories such as rings, gloves, toys etc. In one embodiment, the tokens utilize bio-metric signals to increase the security level of the system.

### 9 Related Work

Related works in three key areas are discussed that pertains to the contributions of the current invention including touch-based interaction, object identification and localization, and energy harvesting.

Capacitive Fingerprinting

[36] propose to use variants of a technique called Swept Frequency Capacitive Sensing to recognize human hand, body configurations, and bio-signatures. The technique fundamentally involves the touch-sensing hardware customized to transmit signals across a band of frequencies which get reflected back from the human contact surface. The signals are detected by a built-in receiver component and analyzed to recognize human body configurations. The drawback of this approach is the hardware customization required to tweak touch-sensors towards the Swept Frequency Capacitive Sensing.

Capacitive Sensing and Coupling.

The idea of using capacitive coupling for very short-range communication has been explored extensively in both, academia and industry. Sample works in this space include Bioamp from Yahoo Labs [37], Microchip Bodycomm [38], Ishin-Den-Shin [39], Sony's TouchNet [40], Ericsson's Connected Me [41], and KAIST Semiconductor System Lab research [42]. This approach involves using the capacitive coupling concept to couple electrical signal, pertaining to the information to be communicated, generated by a external transmitter with a receiver integrated on the mobile device. This mechanism uses the human body as a medium for conducting the signals. The main drawback of this approach is the need for designing a custom receiver as the electrodes and controllers for capacitive coupling are not integrated defacto in mobile devices.

Capacitive proximity sensing kits have become prevalent in recent times; in particular, OpenCapSense [43], Cap-ToolKit [44], and CapNFC [45] provide capacitive receivers to measure capacitance changes caused by human body or object movements. It is notable that this fundamental idea was used for designing short-range communication systems through near-field electro-static coupling, proposed by Zimmerman in 1996 [46]. While these kits provide excellent tools for quick prototyping of capacitive sensing systems, they do not an encapsulate and end-to-end system for identification. HumanAtenna [47] explored the idea of coupling an electric field with human body creating a virtual antenna for sensing body gestures. HumanAtenna requires the transmitter has wall-to-ground connection, making it not suitable for mobile devices.

Object Identification and Localization.

There have been recent works on radio based radar-type tracking systems for precise localization and identification [48-50]. Objects identification can also be achieved through radio tomography and imaging techniques [51, 52], which primarily require a large array of sensors to localize an object. While these techniques are effective in their respective domain, the application to identifying smart tokens may be very challenging considering the deployment cost and energy consumption challenges.

Energy Harvesting.

Recent works have proposed energy harvesting from radio signals [12, 53]. While these systems require the present of radio signals they are constrained with a minimum size requirement to match the wavelength (order of cm to mm) of the radio signal. energy can be also harvested from light emitted from a touch screen [14]. However, not all touch sensing devices are light emitters (e.g. touch pads). Moreover, the effectiveness of the harvesting largely depends on the screen display's brightness which can vary at large; depending on the application and/or users.

### 10 Considerations

The current invention explores the idea of associating identities to touch events on touch-enabled devices. One embodiment of the current invention relates to a token design that incorporates a low-energy and high reliability mechanism to communicate information to touch-sensing devices. By passively modifying the capacitance on touch-sensing surfaces and with help of a touch-sensor profiling mechanism to characterize the touch device, one can communicate IDs through touch at significantly low-energy. It is possible to harvest energy from touch-sensing surface, up to significant amounts that can help operate such touch based ID tokens. Through a user study using a small group we understand that users are typically positive about our proposal however few challenges regarding intricate design details such as miniaturization, theft protection and bio-signal integration remain for future design considerations.

Thus, specific compositions and methods of method and apparatus for battery-free identification token for touch sensing devices have been disclosed. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although the invention has been described with reference to these preferred embodiments, other embodiments can achieve the same results. Variations and modifications of the present invention will be obvious to those skilled in the art and it is intended to cover in the appended claims all such modifications and equivalents. The entire disclosures of all applications, patents, and publications cited above, and of the corresponding application are hereby incorporated by reference.

### REFERENCES

1. Vu, T. et al. “Method, Apparatus, and System for Capacitive Touch Communication,” United States Patent Application Publication Number US 2013-0257804 A1, application Ser. No. 13/853,899, filed Mar. 29, 2013. (published Oct. 3, 2013).
2. Vu, T. et al. “Capacitive Touch Communication: A Technique to Input Data to Capacitive Touchscreen Devices,” U.S. Provisional Patent Application 61/617,144, filed Mar. 29, 2012. (published N/A).
3. Vu, T. et al. (2012) “Distinguishing Users with Capacitive Touch Communication,” Proceedings of MobiCom '12, 1-12.
4. Perrin, S. R. et al. “Touchscreen and Token Interactions,” United States Patent Application Publication Number US 2014-0285463 A1, application Ser. No. 13/847,003, filed Mar. 19, 2013. (published Sep. 25, 2014).
5. Baentsch, M. et al. “Mobile Touch-Generating Device and Communication with a Touchscreen,” U.S. Pat. No. 9,041,668, application Ser. No. 13/527,652, filed Jun. 20, 2012. (issued May 26, 2015).
6. Gillespie, D. W. and Trent, R. A. “System and Method for Authentication of Input Devices,” U.S. Pat. No. 8,458,788, application Ser. No. 12/908,543, filed Oct. 20, 2010. (issued Jun. 4, 2013).
7. Kim, S. et al. (2015) “Fluorescent Light Energy Harvesting Using a Capacitive Touch Screen,” Electron. Lett. 51(21), 1695-1697.
8. Orsley, T. J. “Capacitive Touchscreen or Touchpad for Finger and Active Stylus,” U.S. Pat. No. 8,278,571, application Ser. No. 12/418,181, filed Apr. 3, 2009. (issued Oct. 2, 2012).
9. Myers, M. and Joel Rene Guillemctte, P. F. “Method, Apparatus and System for Gesture Based Security,” United States Patent Application Publication Number US 2016-0162676 A1, application Ser. No. 14/559,035, filed Dec. 3, 2014. (published Jun. 9, 2016).
10. Britt & Jules. (2016) “Snowshoe Stamp.”
11. Scott, J. (2011) “Pushing the Limits of the Touch Screen,” in MIT Technology Review.
12. Talla, V. et al. (2015) “Powering the Next Billion Devices with Wi-Fi,” in Prof. of ACM CoNext.
13. Gummeson, J. et al. (2014) “An Energy Harvesting Wearable Ring Platform for Gesture Input on Surfaces,” in Proceedings of the 12th annual international conference on Mobile systems, applications, and services, pp 162-175, ACM, Bretton Woods, N.H., USA.
14. Wang, W. S. et al. (2008) “Design Considerations of Sub-Mw Indoor Light Energy Harvesting for Wireless Sensor Systems,” Journal on Emerging Technologies in Computing Systems 6(2), 1-26.
15. T. Wang and Blankenship, T. (2011) “Projected Capacitive Touch Systems from the Controller Point of View,” Information Display 3(11), 8-11.
16. So, E. et al. (1999) “Sensing Contact with Analog Resistive Technology,” in Systems, Man, and Cybernetics, 1999. IEEE SMC '99 Conference Proceedings. 1999 IEEE International Conference on, pp 806-811 vol. 802.
17. Evans, B. “Method of and Apparatus for Sensing the Location, Such as Coordinates, of Designated Points on an Electrically Sensitive Touch-Screen Surface,” U.S. Pat. No. 4,806,709, application Ser. No. 07/053,849, filed May 26, 1987. (issued Feb. 21, 1989).
18. Lee, L. L. “Apparatus and Method for Coupling an Acoustical Surface Wave Device to an Electronic Circuit,” U.S. Pat. No. 3,885,173, application Ser. No. 05/404,456, filed Oct. 9, 1973. (issued May 20, 1975).
19. Bhalla, M. R. (2010) “Comparative Study of Various Touchscreen Technologies,” Journal of Computer Apps.
20. Mathema, C. and Wu, C. (2014) “Projected Capacitance Touchscreens Dominate Market.”
21. Hsieh, C. (2014) “Touch-Panel Market Analysis Reports 2008-2014. Technical Report,” DisplaySearch.
22. Avago. (2016) “Hsms-285c.”
23. Microchip. (2016) “Pic12f1571 Datashect.”
24. MEDER. (2016) “Relay Reed.”
25. Android, G. (2016) “Motionevent Class.”
26. Mechanix Glove. (2016) “Tactical Gloves.”
27. OMRON. (2016) “Relay.”
28. Britt & Jules. (2016) “Bluetooth Low Energy Hm-10.”
29. Arduino. (2016) “Arduino Pro Mini.”
30. Sparkfun. (2016) “RFID Module.”
31. M. S. Inc. (2016) “Power Monitor.”
32. Atzori, L. et al. (2010) “The Internet of Things: A Survey,” Computer Network 54(15), 2787-2805.
33. Vu, T. et al. (2012) “Distinguishing Users with Capacitive Touch Communication,” in Proceedings of the 18th annual international conference on Mobile computing and networking, pp 197-208, ACM, Istanbul, Turkey.
34. Kolokowsky, S. and Davis, T. “Not All Touch Screens Are Created Equal: How to Ensure You Are Developing a World-Class Capacitive Touch Product,” EE Times.
35. Chen, Y. et al. (2015) “Your Song Your Way: Rhythm-Based Two-Factor Authentication for Multi-Touch Mobile Devices,” in 2015 IEEE Conference on Computer Communications (INFOCOM), pp 2686-2694.
36. Harrison, C. et al. (2012) “Capacitive Fingerprinting: Exploring User Differentiation by Sensing Electrical Properties of the Human Body,” in Proceedings of the 25th annual ACM symposium on User interface software and technology, pp 537-544, ACM, Cambridge, Mass., USA.
37. Holz, C. and Knaust, M. (2015) “Biometric Touch Sensing: Seamlessly Augmenting Each Touch with Continuous Authentication,” in Proceedings of the 28th Annual ACM Symposium on User Interface Sofiware &#38; Technology, pp 303-312, ACM, Daegu, Kyungpook, Republic of Korea.
38. Microchip. (2016) “Microchip Bodycom™ Technology.”
39. Suzuki, Y. et al. (2016) “Ishin-Den-Shin: Transmitting Sound through Touch.”
40. Matsushita, N. et al. (2000) “Wearable Key: Device for Personalizing Nearby Environment,” in Wearable Computers, The Fourth International Symposium on, pp 119-126.
41. Vajravclu, D. K. (2013) “Connected Me-Proof of Concept.”
42. Yoo, H.-J. et al. (2007) “Low Energy on-Body Communication for Bsn,” in 4th International Workshop on Wearable and Implantable Body Sensor Networks (Bsn 2007): Mar. 26 28, 2007 Rwth Aachen University, Germany (Leonhardt, S., et al., Eds.), pp 15-20, Springer Berlin Heidelberg, Berlin, Heidelberg.
43. Grosse-Puppendahl, T. et al. (2013) “Opencapsense: A Rapid Prototyping Toolkit for Pervasive Interaction Using Capacitive Sensing,” in Pervasive Computing and Communications (PerCom), 2013 IEEE International Conference on, pp 152-159.
44. Wimmer, R. et al. (2007) “A Capacitive Sensing Toolkit for Pervasive Activity Detection and Recognition,” in Fifth Annual IEEE International Conference on Pervasive Computing and Communications (PerCom'07), pp 171-180.
45. Grosse-Puppendahl, T. et al. (2014) “Capacitive near-Field Communication for Ubiquitous Interaction and Perception,” in Proceedings of the 2014 ACM International Joint Conference on Pervasive and Ubiquitous Computing, pp 231-242, ACM, Seattle, Wash.
46. Zimmerman, T. G. (1996) “Personal Area Networks: Near-Field Intrabody Communication,” IBM Systems Journal 35(3-4), 609-617.
47. Cohn, G. et al. (2012) “Humantenna: Using the Body as an Antenna for Real-Time Whole-Body Interaction,” in Proceedings of the SIGCHI Conference on Human Factors in Computing Systems, pp 1901-1910, ACM, Austin, Tex., USA.
48. Adib, F. et al. (2014) “3D Tracking Via Body Radio Reflections,” Proceedings of the 11th USENIX Conference on Networked Systems Design and Implementation, NSDI'14, 317-329.
49. Yang, L. et al. (2014) “Tagoram: Real-Time Tracking of Mobile RFID Tags to High Precision Using Cots Devices,” in Proceedings of the 20th annual international conference on Mobile computing and networking, pp 237-248, ACM, Maui, Hi., USA.
50. Nanzer, J. (2012) Microwave and Millimeter-Wave Remote Sensing for Security Applications, Johns Hopkins University.
51. Patwari, N. et al. (2014) “Brcathfinding: A Wireless Network That Monitors and Locates Breathing in a Home,” IEEE Journal of Selected Topics in Signal Processing 8(1), 30-42.
52. Wei, B. et al. (2015) “Drti: Directional Radio Tomographic Imaging,” Proceedings of the 14th International Conference on Information Processing in Sensor Networks, IPSN '15, 166-177.
53. Mishra, D. et al. (2015) “Charging Time Characterization for Wireless Rf Energy Transfer,” IEEE Transactions on Circuits and Systems II: Express Briefs 62(4), 362-366.

We claim:

1. A battery free token comprising a signal generating circuit, an energy harvesting module, an interactive device surface, and at least one electrode, wherein said electrode is electrically coupled to the circuit and configured to communicate signals from said signal generating circuit to said interactive device surface, wherein said signals comprises an arbitrary data sequence, wherein said energy harvesting module is electronically connected to said signal generating circuit and said interactive device surface.

2. The device of claim 1, wherein said energy harvesting module comprises a storage capacitor connected to said electrode.

3. A system for capacitive touch communication, the system comprising:
a) a first device comprising a signal generating circuit, an energy harvesting module, a first device surface, and at least one electrode, wherein said electrode is electrically coupled to the circuit and configured to communicate signals from said signal generating circuit to said first device surface, wherein said energy harvesting module is electronically connected to said signal generating circuit and first device surface, and
b) a second device comprising: a processor and a capacitive touch sensor surface; and a computer-readable storage medium storing instructions that, when executed, cause the processor to: receive a sequence of touch events from the touch sensor surface generated in response to the varying capacitance of the capacitive touch-screen caused by an external source; and identify the sequence of touch events as belonging to an unique external source,
wherein said signal generating circuit is configured to modify the effective capacitance between said capacitive touch-sensor and said first device surface, wherein said modifying of said effective capacitance comprises a pattern, wherein said pattern comprises transmission of an arbitrary data sequence.

4. The system of claim 3, wherein said modification of the effective capacitance between said first and second device comprises transmission of bits by emulating a series of contact/no-contact made on the capacitive touch sensor surface.

5. The system of claim 3, wherein said rate of generation of touch events depends on the probe frequency of said capacitive touch sensor surface.

6. The system of claim 3, wherein said energy harvesting module comprises a storage capacitor connected to said electrode, wherein said capacitor which absorbs voltage leak from said capacitive touch sensor surface when contacted with said electrode.

7. The system of claim 3, wherein the system further comprises additional devices comprising a signal generating circuit, an energy harvesting module, a first device surface, and at least one electrode, wherein said electrode is electrically coupled to the circuit and configured to communicate signals from said signal generating circuit, wherein said signal generated is uniquely identifiable from other devices in said system.

8. The system of claim 3, wherein said signal generating circuit comprises an electrical switch.

9. The system of claim 3, wherein said electrode comprises a conductive surface.

10. The system of claim 3, wherein the length of the data to be transmitted is greater than 10 bit.

11. The system of claim 3, wherein said energy harvesting module comprises a band pass filter, a rectifier, and a capacitor in electronic communication with said electrode.

12. The system of claim 3, wherein said first device communicates with said second device though the body of a system user.

13. The system of claim 9, wherein said energy harvesting module is in electronic communication with the second device surface.

14. The system of claim 3, wherein said first device communicates with said second device though the body of a system user.

15. The system according to claim 12, further comprising a second electrode electrically coupled to the circuit configured to communicate the signal to the external device using a user's body as a communication medium, wherein the electrode is in contact with the user and the user is in contact with the capacitive touch screen.

16. A method of using the system of claim 3 wherein a user employs the first device to communicate with a touch-sensor of the second device, the method comprising: generating, by the user device, a signal encoding a data sequence; communicating the signal from the user device, to the electronic device by varying a capacitance of the touch-screen thereof; and receiving and decoding, by the electronic device, the signal to obtain an identifiable data sequence.
